(19) United States
(12) Patent Application Publication
(10) Pub. No.: US 2005/0123644 A1
(43) Pub. Date: Jun. 9, 2005

(54) Phosphate-containing fertilizer derived from steepwater

(75) Inventors: Dirk Reif, Eden Prairie, MN (US); Ting Liu Carlson, Dayton, OH (US)

Correspondence Address: PERKINS COIE LLP;PATENT-SEA, P.O. BOX 1247, SEATTLE, WA, 98111-1247, US

(73) Assignee: Cargill, Incorporated, Wayzata, MN (US)

(21) Appl. No.: 10/984,194

(22) Filed: Nov. 9, 2004

Related U.S. Application Data
(63) Continuation-in-part of application No. PCT/US03/02354, filed on Jan. 24, 2003.

(51) Int. Cl. A21D 2/24

(52) U.S. Cl. 426/23

(57) ABSTRACT

This invention relates to fertilizer compositions containing phosphorus that is derived from steepwater, e.g., corn steepwater, and methods of making fertilizer from steepwater. In one implementation, steepwater is mixed with an alkaline metal hydroxide, which is added in an amount effective to precipitate at least about 75% of the phosphorus in the steepwater. A phosphorus-rich precipitate is separated from the steepwater; the precipitate includes an organic phosphorous component and an inorganic phosphorous component, which may include a phosphorous salt of the metal. At least a majority of the organic phosphorus component may be converted to inorganic phosphorous, improving its bioavailability to growing plants.

### CROSS-REFERENCE TO RELATED APPLICATIONS

This application is a continuation-in-part of PCT International Application No. PCT/US03/02354, filed 24 Jan. 2003 and entitled LOW PHOSPHOROUS ANIMAL FEED AND METHOD FOR MAKING SAME. This application also claims the benefit of U.S. Provisional Application No. 60/518,189, filed 7 Nov. 2003 and entitled PHOSPHATE CONTAINING FERTILIZER, and U.S. Provisional Application No. 60/351,725, filed 24 Jan. 2002. The entirety of each of these applications is incorporated herein by reference.

### TECHNICAL FIELD

This invention generally relates to fertilizer compositions. Select embodiments provide fertilizers containing phosphorus derived from steepwater, e.g., corn steepwater, and methods of making such fertilizers from steepwater.

### BACKGROUND

Wet milling of corn is a common technique in the commercial production of corn starch, corn syrup, and corn oil, among other corn products. In wet milling, the corn is steeper prior to breaking the corn. Steeping softens the kernels, making it easier to separate the corn into its components.

Corn contains phosphorous, primarily in the form of an organic phosphorous-containing compound, phytate. Steeping leeches phytate, along with a variety of other corn solubles, out of the corn. The soaked corn kernels can be removed, leaving a steepwater that includes phosphorous and other corn solubles. After reduction to remove excess water, steepwater can be used in a variety of further applications, including use as part of an animal feed or as a nutrient source for fermentation processes.

Phytate is poorly digested by monogastric animals. Although ruminants, e.g., cattle, can digest phytate, excess dietary phytate and other phosphates in a ruminant diet will pass through the animal's gastrointestinal tract to be excreted as manure. Excessive amounts of phosphorous from animal manure is undesirable from an environment standpoint. Furthermore, phytate can associate with multivalent cations. Some multivalent cations, e.g., calcium, are important nutritional elements in the animal's diets; phytate's association with these cations can interfere with their bioavailability to the animal.

### BRIEF DESCRIPTION OF THE DRAWINGS

FIG. 1 is a process diagram schematically illustrating components of a facility that may be used to carry out aspects of the invention.

FIG. 2 is a bar graph schematically comparing samples made in accordance with various embodiments of the invention to a commercially available starter fertilizer.

### DETAILED DESCRIPTION

A. Overview

Embodiments of the invention provide methods for making fertilizers that include phosphorus and may additionally include primary nutrients (e.g., nitrogen and potassium), secondary nutrients (e.g., sulfur, calcium, magnesium), and micro nutrients (e.g., metals). Some methods contemplate removing phytate from steepwater from wet corn milling by mixing the steepwater with an alkaline hydroxide, such as calcium hydroxide, magnesium hydroxide, ammonium hydroxide, or mixtures thereof. The hydroxide converts the phytate to an alkaline metal salt and/or ammonium salt (phytin), which precipitates to provide a phosphorous-rich precipitate and a reduced-phosphorous steepwater.

In one approach, the amount of alkaline metal and/or ammonium hydroxide added is effective to precipitate the phosphorous in the steepwater and to provide an alkaline metal- or ammonium-phytin complex or associate the divalent metal and/or ammonium ion with the phytin such that the phytin will precipitate with the calcium metal ions, magnesium metal ions, and/or ammonium ions. Calcium ions are believed to work better to precipitate phosphorus than other ions, even when the other ions are in an environment having a high pH. The alkaline metal or ammonium ions may also form complexes and precipitate a small amount of inorganic phosphate from the steepwater. Generally, the alkaline metal and/or ammonium hydroxide may be present in an amount sufficient to provide a pH of greater than about 5.5 and preferably greater than about 6.0.

The molar ratio of calcium to phosphorus may be selected to precipitate at least 75%, preferably 80% or more, of the phosphorus; a Ca/P ratio of at least about 1, preferably greater than about 1.0, is expected to suffice. The ion/phytin complex is separated from the steepwater to provide a low-phosphorous steepwater. This precipitated ion/phytin complex and other co-precipitates can be used directly as a fertilizer or fertilizer component. In one useful embodiment, the precipitate is further processed to free up the phosphorus for use as a fertilizer or component thereof.

The phosphorous-rich precipitate removed from the steepwater may also contain other primary nutrients, such as nitrogen (typically from protein) and potassium; secondary nutrients such as calcium and sulfur; and many micronutrients, e.g., iron, copper, magnesium, and oxalate. These other important fertilizer nutrients may co-precipitate with the ion/phytin complex.

B. Definitions

“Phytate” means myoinositol 1,2,3,4,5,6-hexakis (dihydrogen phosphate). This compound associates with cations and forms complexes, which are sometimes called phytin. We shall also describe these metal or ammonium ion/phytate-associated molecules as phytin complexes.

“Corn gluten feed” is a by-product of the wet milling of corn for products such as corn starch and corn syrup. Corn gluten feed generally includes corn germ, corn bran, corn solubles, cracked corn, and fermentation end products.

Maize Components: Botanically, a maize kernel or corn kernel is known as a caryopsis, a dry, single-seeded, nutlike berry in which the fruit coat and the seed are fused to form a single grain. Mature kernels have four major parts: pericarp (hull or bran), germ (embryo), endosperm, and tip cap.

An average composition of whole maize, and its fractions, on a moisture-free (dry) basis is as follows.

TABLE A

| Fraction of | Kernel | Starch | Protein | Lipid | Sugar | Ash |
|---|---|---|---|---|---|---|
| Whole Maize | wt % | wt % | wt % | wt % | wt % | wt % |
| Whole grain | 100 | 71.5 | 10.3 | 4.8 | 2.0 | 1.4 |
| Endosperm | 82.3 | 86.4 | 9.4 | 0.8 | 0.6 | 0.3 |
| Germ | 11.5 | 8.2 | 18.8 | 34.5 | 10.8 | 10.1 |
| Pericarp | 5.3 | 7.3 | 3.7 | 1.0 | 0.3 | 0.8 |
| Tip cap | 0.8 | 5.3 | 9.1 | 3.8 | 1.6 | 1.6 |

Germ: The scutellum and the embryonic axis are the two major parts of the germ. The scutellum makes up 90% of the germ, and stores nutrients mobilized during germination. During this transformation, the embryonic axis grows into a seedling. The germ is characterized by its high fatty oil content. It is also rich in crude proteins, sugars, and ash constituents. The scutellum contains oil-rich parenchyma cells, which have pitted cell walls. Of the sugars present in the germ, about 67% is glucose.

Endosperm: The endosperm contains the atarch, and is lower in protein content than the germ and the bran. It is also low in crude fat and ash constituents.

Pericarp: The maize kernel is covered by a water impermeable cuticle. The pericarp (hull or bran) is the mature ovary wall beneath the cuticle and comprises all the outer cell layers down to the seed coat. It is high in non-starch-polysaccharides, such as cellulose and pentosans. A pentosan is a complex carbohydrate present in many plant tissues, particularly brans, characterized by hydrolysis to give five-carbon atom monosaccharides (pentoses). It is any member of a group of pentose polysaccharides found in various foods and plant juices. Because of its high fiber content, the pericarp is tough.

Tip cap: The tip cap, where the kernel is joined to the cob, is a continuation of the pericarp, and is usually present during shelling. It contains a loose and spongy parenchyma.

C. Equipment

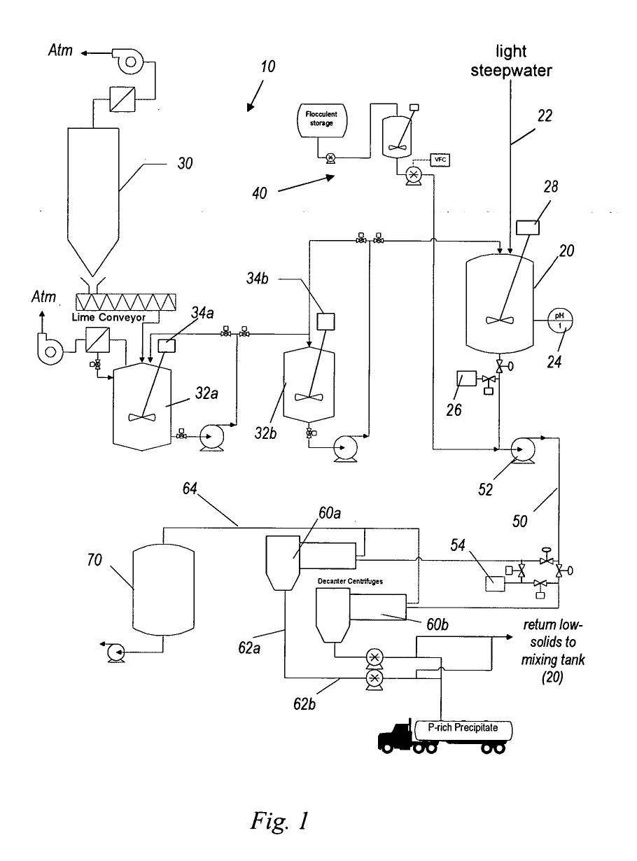

FIG. 1 schematically illustrates a steepwater processing system 10 in accordance with one embodiment of the invention. This system 10 includes a mixing tank 20 that receives a supply of steepwater via a steepwater supply line 22 and a supply of a suitable alkaline hydroxide via feed line 36. A pH adjustment supply 24 may deliver any additional components needed to adjust the pH of the contents of the mixing tank 20. If so desired, a process water supply 26 may also be coupled to the mixing tank. The contents of the mixing tank may be continuously mixed by a mixer 28.

As discussed below, a variety of alkaline hydroxides may be combined with the steepwater in accordance with different embodiments of the invention. In the particular embodiment shown in FIG. 1, the alkaline hydroxide delivered via supply line 36 is lime, i.e., calcium hydroxide. A lime silo 30 may hold lime for delivery to a pair of mixing tanks 32a and 32b. In the illustrated embodiment, lime from the silo 30 is delivered to the first mixing tank 32a and mixed with water by a mixer 34a. A portion of the resultant lime slurry may be delivered to the second mixing tank 32b, which is continuously mixed by a mixer 34b. This ensures a ready supply of lime slurry to meet the process needs in the mixing tank 20.

After suitable processing as detailed below, the steepwater and an entrained phosphate-rich precipitate may be delivered to at least one separator 60 by a delivery line 50. In the illustrated embodiment, a flocculent supply 40 may deliver a flocculent to a pump 52 for delivery to the separator(s) 60. A process water supply 54 may add any additional water necessary for the separator(s) 60.

The specific system shown in FIG. 1 employs a pair of decanter centrifuges 60a and 60b. Suitable decanter centrifuges are commercially available, e.g., from Wesffalia. If so desired, the separated phosphate-rich precipitate may be delivered to a storage or processing facility. A reduced-phosphate steepwater may be delivered to a collection tank 70 via delivery line 64. In one embodiment, the steepwater may be allowed to settle in the tank 70 to reduce any foam that may have formed in the centrifuges 60. As explained in PCT International Publication No. WO 03/061403 (the entirety of which is incorporated herein by reference), the reduced-phosphorous steepwater in the tank 70 may be further processed for reuse, e.g., as a component of an animal feed.

D. Process

The first step in the wet milling of corn is steeping, in which corn is soaked in water under controlled processing conditions. Controlling temperature, time, sulfur dioxide (SO₂) concentration, and lactic acid content has been found to promote diffusion of water through the tip cap of the corn kernel into the germ and endosperm. Steeping softens the kernels, facilitating separation of the components of corn.

Bulk corn is cleaned on vibrating screens to remove coarse material and fine material. These screenings removed from the corn kernels are used for animal feed. If allowed to remain with the corn, fine material can cause processing problems such as restricted water flow through steeps and screens and increased steep liquor viscosity.

Steeping is well known in the art and need not be detailed here. Steeping parameters useful in connection with some embodiments of the invention are set forth in PCT International Publication No. WO 03/061403, the entirety of which is incorporated herein by reference. Generally, though, steeping involves putting corn into tanks and covering the corn with water. The corn and water blend may be heated to about 125° F. and held for about 22 to about 50 hours. Steeping may be done by continuously adding dry corn at the top of the steep while continuously withdrawing steeped corn from the bottom.

Water from the steeping accumulates corn solubles. The water may be treated with SO₂ to a concentration of about 0.12 to about 0.20 weight percent. The SO₂ increases the rate of water diffusion into the kernel and assists in breaking down the protein-starch matrix, which is necessary for high starch yield and quality.

Water moves from one steep tank to another and as the water is advanced from steep to steep, the SO₂ content decreases and bacterial action increases. This results in the growth of lactic acid bacteria. The lactic acid concentration is from about 16 to about 20% (dry basis) after the water has advanced through the steeping system and been withdrawn as light steepwater (steepwater without water evaporated therefrom). Meanwhile, the SO₂ content drops to about 0.01% or less.

During steeping some water is absorbed by the corn to increase its moisture content from about 16 weight percent to about 45 weight percent. Unabsorbed water is withdrawn from the steeping system. This light steepwater contains corn solubles soaked out of the corn, which include phosphorous and may also include one or more of protein, manganese, zinc, molybdenum, copper, and iron. The steepwater is mixed with a base, e.g., Ca(OH)₂ and/or Mg(OH)₂, to precipitate the phytate in the steepwater as described below. Precipitation with calcium hydroxide is preferred; calcium ions work better to precipitate phosphorus than alternative ions even when the other ions are in a high pH environment.

One implementation of the invention employs a light steepwater that contains about 1-30 weight percent (wt %) solids, preferably about 4-13 wt % solids, and about 0.1 to about 3 wt % phytate, preferably about 0.4-1.3 wt % phytate, with a pH of about 3.5 to about 4.5. This light steepwater may be mixed with a sufficient amount of alkaline metal hydroxide (e.g., calcium hydroxide or magnesium hydroxide), and/or ammonium hydroxide to raise its pH to at least about 5.5 and to precipitate at least about 75% of total phosphorus in steepwater, typically as phytin and insoluble phosphates, e.g., calcium phosphate. In one embodiment, more than about 90 wt % of phytate and about 20 wt % to about 50 wt % of inorganic phosphate are precipitated out of steepwater as the calcium salt. The amount of hydroxide will vary depending on the pH of the starting steepwater and the desired degree of phosphorous removal. Generally, though, the hydroxide may be added to a concentration of at least about 0.07 wt %, e.g., about 0.07-3.0 wt %, and preferably about 0.3 to about 1.0 wt %.

The method may also precipitate out at least about 80 wt %, e.g., 90 wt % or more, of total oxalate in the steepwater as calcium oxalate. The resulting steepwater contains white calcium phytate/phosphate precipitate and calcium oxalate precipitate, which may be separated (e.g., by vacuum filtration or horizontal basket centrifugation) to produce a low-phosphorous steepwater and a phosphorous-rich precipitate that includes calcium phytate and calcium oxalate. In one embodiment that employed centrifugal separation, the precipitate included between 28 wt % and 32 wt % dissolved solids (DS).

One embodiment provides a precipitate that includes phosphorous and at least one other fertilizer nutrient, which may be a primary nutrient, a secondary nutrient, or a micronutrient. Suitable primary nutrients include nitrogen and potassium. Secondary nutrients include calcium magnesium, and sulfur and micronutrients commonly are metals such as manganese, zinc, molybdenum, copper, and iron. Depending on the treatment of the precipitate, the building blocks (i.e., carbon, hydrogen, and oxygen) may also be available. Analysis of the precipitate on a dry basis typically finds about 10-17 wt % total phosphorus, about 10-14 wt % calcium, about 9-24 wt % protein, about 2.45-3.55 wt % magnesium, and about 0.66-1.63 wt % sulfur.

Treatment of the precipitate can yield a fertilizer that has bio-available phosphorus as well as other essential elements. The organically bound phosphorus can be converted to a more bio-available inorganic phosphorus by chemical hydrolysis, enzymatic hydrolysis, or combustion.

For chemical hydrolysis, the precipitate may be dissolved in a mineral acid (e.g., sulfuric or hydrochloric acid) to a final pH of 2.0-3.5, desirably about 3, and heated to about 100° C. for several hours. Reaction time can vary depending on optimal conditions and desired level of hydrolysis, but 100% hydrolysis can occur after 24 hrs.

For enzymatic hydrolysis the precipitate is dissolved in mineral acid (e.g., sulfuric or hydrochloric acid) to a final pH of 2.0-3.5 and treated with about 0.1 wt % to 0.33 wt % of a phytase enzyme. Reaction is held at 37° C. for several hours. 100% hydrolysis can occur after 24 hrs, but hydrolysis time can vary depending on how much enzyme is used, what temperature is chosen, and what level of hydrolysis is desired.

In one embodiment, the precipitate is combusted to convert the organic bound phosphorus to inorganic phosphorus. In one example, the precipitate was dried to the following specifications: Moisture 3.79%, Carbon 18.0%, Hydrogen 3.36%, Nitrogen 2.56%, Sulfur 0.39%, Ash 52.4% and Oxygen 9.54% (by difference). Combusting the dry material released 3083 BTU/lb and yielded an ash with the following elemental analysis: SiO₂<0.01 wt %, Al₂O₃<0.01 wt %, TiO₂<0.01 wt %, Fe₂O₃0.38 wt %, CaO 30.80 wt %, MgO 7.63 wt %, Na₂O 0.02 wt %, K₂O 6.76 wt %, P₂O₅ 55.06 wt %, SO₃ 0.01 wt %.

### E. EXAMPLES

### Example I

Method of Making Low Phosphorus Reduced Steepwater: Various amounts of lime (calcium hydroxide) is added to light steepwater at about 50-600° C. with mixing to precipitate a phosphorous-rich precipitate. The mixture is filtered through a filter under vacuum to remove precipitate solids. The total phosphorus content can be measured by various analytical methods. One analytical method involves the use of phytase to hydrolyze phytate to free phosphates and measuring free phosphates with an ion chromatography.

The phytase hydrolysis reaction of the analytical method was done at about 379° C. for 4 hours in 0.2 M citrate buffer with a pH of 5. Under these analytical conditions, 96% of total phosphate is hydrolyzed from phytate. In this example, more than 80% of total phosphorus in steepwater precipitated out at a pH of at least about 5.5 and a calcium to phosphorus molar ratio (Ca/P) of about 0.75 or greater. Analysis of the calcium phytate precipitate collected at pH=6.4 found the precipitate contained about 11% protein, 56% ash, 13.9% calcium, 17.6% phosphorus, 3.6% magnesium, and 1.6% sulfur. The starting steepwater solids contain 3.6% phosphorus and the low phosphorus steepwater solids contain only 0.5% phosphorus. More than 85% of total phosphorus is removed from the steepwater.

Steepwater from another source was also processed as indicated above. Results of processing were as follows:

TABLE 1
Phosphorous and Oxalate Removal with varying pH and Ca/P

| | | % P | % oxalate |
|---|---|---|---|
| pH | Ca/P | Removed | Removed |
| 6.14 | 1.58 | 87.4 | 92.8 |
| 5.62 | 1.42 | 83.6 | 89.4 |
| 5.29 | 1.25 | 69.0 | 81.8 |
| 5.07 | 1.10 | 52.7 | 84.9 |
| 4.95 | 0.95 | 40.5 | 82.1 |
| 4.76 | 0.79 | 10.2 | 81.2 |
| 4.56 | 0.63 | 2.1 | 89.2 |
| 4.37 | 0.47 | 7.5 | 90.3 |
| 4.14 | 0.33 | 3.7 | 85.7 |
| 4.10 | 0.16 | 0 | 64.9 |
| 3.97 | 0.03 | 3.3 | 0 |

### EXAMPLE II

Materials and Methods:

A phosphorous-rich precipitate was formed generally as outlined above and quantities of the precipitate were collected over time to obtain a composite sample that reflected fluctuations in the wet mill operation. The composite sample was dried using a tray dryer and ground to a fine granular consistency. The composite sample was stored in a clean, dry 55-gallon drum to form a inventory of 200-500 lbs. Aliquots of the sample were used as starting material for pH adjustment, hydrolysis, and final pH adjustments as indicated below.

Sample 1: A sample of the phosphorous-rich precipitate was tray dried at 50° C. and ground to fine granular consistency. Table 1 lists the chemical analysis on a weight percent basis, fertilizer nutrients (pounds of nutrient/ton of dried precipitate), and the analytical method employed in each measurement.

TABLE 2
Phosphorous-rich Precipitate (Sample 1)

| Sample 1 | Analysis | Nutrients | Analysis |
|---|---|---|---|
| Parameters | wt % | lbs/ton | Method |
| Ammonium Nitrogen (N) | 0.01 | 0.3 | EPA 350.2 |
| Organic Nitrogen (N) | 2.81 | 56.2 | EPA 350.2 |
| Total Nitrogen (N) | 2.82 | 56.4 | EPA 351.3 |
| Phosphorus (P₂O₅) | 19.36 | 387.2 | EPA 200.7 |
| Potassium (K₂O) | 2.58 | 51.5 | EPA 200.7 |
| Sulfur (S) | 0.37 | 7.4 | EPA 200.7 |
| Calcium (Ca) | 9.37 | 187.3 | |
| Magnesium (Mg) | 1.97 | 39.4 | EPA 200.7 |
| Sodium (Na) | 0.02 | 0.3 | EPA 200.7 |
| Copper (Cu) | 7 ppm | 0.01 | EPA 200.7 |
| Iron (Fe) | 641 ppm | 1.28 | EPA 200.7 |
| Manganese (Mn) | 240 ppm | 0.48 | EPA 200.7 |
| Zinc (Zn) | 555 ppm | 1.11 | EPA 200.7 |
| Moisture | 14.5 | | EPA 160.3 |
| Total Solids | 85.5 | 1710 | Wheatstone |
| Total Salts | | 278.8 | EPA 120.1 |
| pH | 6.4 | | EPA 150.1 |
| Ash | 37.2 | | Calc. |
| Phosphate Available (P₂O₅) | 18.82 | | Calc. |

Sample 2: A sample of the phosphorous-rich precipitate was slurried in water to 33 D.S. and adjusted with sulfuric acid to pH 3.5 at room temperature. The slurry was then tray dried at 50 C and ground to fine granular consistency. Table 3 lists the chemical analysis on a weight percent basis, fertilizer nutrients (pounds of nutrient/ton of dried precipitate), and the analytical method employed in each measurement.

TABLE 3
Acidified Phosphorous-rich Precipitate (Sample 2)

| Sample 2 | Analysis | Nutrients | Analysis |
|---|---|---|---|
| Parameters | wt % | lbs/ton | Method |
| Ammonium Nitrogen (N) | 0.04 | 0.8 | EPA 350.2 |
| Organic Nitrogen (N) | 2.38 | 47.6 | EPA 350.2 |
| Total Nitrogen (N) | 2.42 | 48.5 | EPA 351.3 |
| Phosphorus (P₂O₅) | 18.34 | 366.8 | EPA 200.7 |
| Potassium (K₂O) | 1.89 | 37.8 | EPA 200.7 |
| Sulfur (S) | 4.8 | 96 | EPA 200.7 |
| Calcium (Ca) | 9.83 | 196.6 | EPA 200.7 |
| Magnesium (Mg) | 1.77 | 35.4 | EPA 200.7 |
| Sodium (Na) | 0.02 | 0.4 | EPA 200.7 |
| Copper (Cu) | 6 ppm | 0.01 | EPA 200.7 |
| Iron (Fe) | 610 ppm | 1.22 | EPA 200.7 |
| Manganese (Mn) | 235 ppm | 0.47 | EPA 200.7 |
| Zinc (Zn) | 583 ppm | 1.17 | EPA 200.7 |
| Moisture | 11.2 | | EPA 160.3 |
| Total Solids | 88.8 | 1776 | Wheatstone |
| Total Salts | | 371 | EPA 120.1 |
| pH | 4 | | EPA 150.1 |
| Ash | 39.6 | | Calc. |
| Phosphate Available (P₂O₅) | 18.21 | | Calc. |

Sample 3: A sample of the phosphorous-rich precipitate was slurried in water to 33 D.S. and adjusted with sulfuric acid to pH 3.5. The slurry was hydrolyzed by heating to 100 C until ion chromatographic analyses indicate >85% PO₄ hydrolysis. The slurry was tray dried at 50 C and ground to fine granular consistency. The chemical analyses, lbs/ton of fertilizer nutrients, and analytical methods for the hydrolyzed calcium phytate precipitate are given in Table 4.

TABLE 4
Hydrolyzed Phosphorous-rich Precipitate (Sample 3)

| Sample 3 | Analysis | Nutrients | Analysis |
|---|---|---|---|
| Parameters | wt % | lbs/ton | Method |
| Ammonium Nitrogen (N) | 0.07 | 1.5 | EPA 350.2 |
| Organic Nitrogen (N) | 2.13 | 42.6 | EPA 350.2 |
| Total Nitrogen (N) | 2.2 | 44 | EPA 351.3 |
| Phosphorus (P₂O₅) | 13.78 | 275.7 | EPA 200.7 |
| Potassium (K₂O) | 1.62 | 32.4 | EPA 200.7 |
| Sulfur (S) | 6.5 | 130 | EPA 200.7 |
| Calcium (Ca) | 8.99 | 179.7 | EPA 200.7 |
| Magnesium (Mg) | 1.3 | 26 | EPA 200.7 |
| Sodium (Na) | 0.01 | 0.2 | EPA 200.7 |
| Copper (Cu) | 7 ppm | 0.01 | EPA 200.7 |
| Iron (Fe) | 478 ppm | 0.96 | EPA 200.7 |
| Manganese (Mn) | 176 ppm | 0.35 | EPA 200.7 |
| Zinc (Zn) | 440 ppm | 0.88 | EPA 200.7 |
| Moisture | 17.9 | | EPA 160.3 |
| Total Solids | 82.1 | 1642 | Wheatstone |
| Total Salts | | 239.8 | EPA 120.1 |
| pH | 2.6 | | EPA 150.1 |
| Ash | 31.3 | | Calc. |
| Phosphate Available (P₂O₅) | 13.56 | | Calc. |

Sample 4: A sample of the phosphorous-rich precipitate was slurried in water to 33 D.S. and adjusted with sulfuric acid to pH 3.5. The slurry was hydrolyzed by heating to 100° C. until ion chromatographic analyses indicated >85% PO₄ hydrolysis. The material was cooled to ambient temperature and the pH was adjusted to 7.0 with aqua ammonia. The slurry was tray dried at 50° C. and ground to fine granular consistency. The chemical analyses, lbs/ton of fertilizer nutrients, and analytical methods for the resultant hydrolyzed, ammonia-adjusted precipitate are given in Table 5.

TABLE 5
Hydrolyzed, Ammonia-adjusted Precipitate (Sample 4)

| Sample 4 | Analysis | Nutrients | Analysis |
|---|---|---|---|
| Parameters | wt % | lbs/ton | Method |
| Ammonium Nitrogen (N) | 5.78 | 115.5 | EPA 350.2 |
| Organic Nitrogen (N) | 2.25 | 45 | EPA 350.2 |
| Total Nitrogen (N) | 8.03 | 160.7 | EPA 351.3 |
| Phosphorus (P₂O₅) | 15.44 | 308.8 | EPA 200.7 |
| Potassium (K₂O) | 1.78 | 35.7 | EPA 200.7 |
| Sulfur (S) | 5.53 | 110.6 | EPA 200.7 |
| Calcium (Ca) | 7.56 | 151.2 | EPA 200.7 |
| Magnesium (Mg) | 1.46 | 29.2 | EPA 200.7 |
| Sodium (Na) | 0.01 | 0.2 | EPA 200.7 |
| Copper (Cu) | 6 ppm | 0.01 | EPA 200.7 |
| Iron (Fe) | 493 ppm | 0.99 | EPA 200.7 |
| Manganese (Mn) | 198 ppm | 0.4 | EPA 200.7 |
| Zinc (Zn) | 483 ppm | 0.97 | EPA 200.7 |
| Moisture | 15.2 | | EPA 160.3 |
| Total Solids | 84.8 | 1696 | Wheatstone |
| Total Salts | | 331.8 | EPA 120.1 |
| pH | 6.2 | | EPA 150.1 |
| Ash | 30.5 | | Calc. |
| Phosphate Available (P₂O₅) | 15.35 | | Calc. |

Sample 5: A sample of the phosphorous-rich precipitate was slurried in water to 33 D.S. and adjusted with sulfuric acid to pH 3.5. The slurry was hydrolyzed by heating to 100° C. until ion chromatographic analyses indicated >85% PO₄ hydrolysis. The material was cooled to ambient temperature and pH adjusted to 7.0 with calcium hydroxide. The slurry was tray dried at 50° C. and ground to fine granular consistency. The chemical analyses, lbs/ton of fertilizer nutrients, and analytical methods for the resultant hydrolyzed, calcium hydroxide-adjusted precipitate are given in Table 6.

TABLE 6
Hydrolyzed, calcium hydroxide-adjusted Precipitate (Sample 5)

| Sample 5 | Analysis | Nutrients | Analysis |
|---|---|---|---|
| Parameters | wt % | lbs/ton | Method |
| Ammonium Nitrogen (N) | 0.01 | 0 | EPA 350.2 |
| Organic Nitrogen (N) | 1.64 | 32.8 | EPA 350.2 |
| Total Nitrogen (N) | 1.65 | 33.1 | EPA 351.3 |
| Phosphorus (P₂O₅) | 12.04 | 240.8 | EPA 200.7 |
| Potassium (K₂O) | 1.42 | 28.4 | EPA 200.7 |
| Sulfur (S) | 4.4 | 88.1 | EPA 200.7 |
| Calcium (Ca) | 17.19 | 343.8 | EPA 200.7 |
| Magnesium (Mg) | 1.19 | 23.8 | EPA 200.7 |
| Sodium (Na) | 0.01 | 0.2 | EPA 200.7 |
| Copper (Cu) | 5 ppm | 0.01 | EPA 200.7 |
| Iron (Fe) | 429 ppm | 0.86 | EPA 200.7 |
| Manganese (Mn) | 152 ppm | 0.3 | EPA 200.7 |
| Zinc (Zn) | 365 ppm | 0.73 | EPA 200.7 |
| Moisture | 11.9 | | EPA 160.3 |
| Total Solids | 88.1 | 1762 | Wheatstone |
| Total Salts | | 396.2 | EPA 120.1 |
| pH | 9.1 | | EPA 150.1 |
| Ash | 52.2 | | Calc. |
| Phosphate Available (P₂O₅) | 11.82 | | Calc. |

### EXAMPLE III

An acid, southern Iowa soil was air-dried and three kilograms of soil were added to each of a number of clean plastic greenhouse pots. The soil from each pot was transferred to a mixer to which appropriate amounts of limestone and a phosphate source were added to reach a particular pH and phosphorous content. Each pot contained either no additional phosphate source or one of seven different phosphate sources: di-ammonium phosphate (DAP), a commercially available 18-46-0 starter fertilizer, and Samples 1-5 from Example II above. After mixing, the treated soil was returned to its pot. four corn seeds were planted in each pot, and water was applied to achieve field capacity. After emergence, only two plants were kept in each pot. After nine weeks, the plants were harvested by cutting the stalks at one-half inch above the soil. Harvested plants were placed in paper bags, weighted and dried at 65° C. until constant weight was achieved. Dried plants and bags were weighed and the plant material was ground. Empty bags were weighed to enable determination of fresh and dried plant yields. Microwave digestion procedures were used to prepare plant samples for elemental analysis and total nitrogen was determined by dry combustion in a LECO CHN analyzer.

Corn germinated, grew and developed normally throughout the study with byproduct and fertilizer treated soils producing the greater growth than the check treatment. Tables 7 and, 8 present dry matter yield and compositional analysis and uptake of nutrients by the corn plants. A two-factor variance analysis showed that there were statistically significant differences (p-values less than 0.01) between the phosphorous sources in dry matter yield and in the corn contents of phosphorus, potassium, copper, iron, magnesium, and zinc. Treatment of the soil with limestone significantly altered corn magnesium and manganese contents; manganese uptake is greater in acid soils than near neutral soils.

TABLE 7
Corn plant yield and tissue analysis.

| | | Fresh wt. | Dry wt. | Total N | P | K | Al | Ca | Cu | Fe | Mg | Mn | Na | Zn |
|---|---|---|---|---|---|---|---|---|---|---|---|---|---|---|
| Source | Liming | grams | | % | ppm | % | ppm | | | | | | | |
| No fertilizer | No lime | 87 | 13.8 | 0.929 | 680 | 2.50 | 54 | 3,929 | 27 | 45 | 2,788 | 83 | 16 | 40 |
| added | pH 6.5 | 106 | 17.4 | 0.956 | 887 | 2.26 | 67 | 5,158 | 20 | 76 | 3,201 | 30 | 18 | 41 |
| | pH 6.9 | 114 | 18.5 | 0.859 | 853 | 1.99 | 31 | 5,437 | 17 | 50 | 3,128 | 36 | 18 | 45 |
| 18-46-0 fertilizer | No lime | 185 | 43.3 | 0.525 | 1,449 | 1.59 | 63 | 3,631 | 23 | 43 | 2,433 | 101 | 25 | 26 |
| added | pH 6.5 | 173 | 33.3 | 0.694 | 1,656 | 1.45 | 25 | 3,399 | 12 | 24 | 2,776 | 28 | 14 | 24 |
| | pH 6.9 | 210 | 44.0 | 0.704 | 1,587 | 1.29 | 24 | 4,358 | 11 | 24 | 3,103 | 34 | 16 | 25 |
| Sample 1 | No lime | 239 | 49.5 | 0.483 | 2,002 | 1.38 | 41 | 3,125 | 13 | 22 | 2,369 | 80 | 17 | 25 |
| added | pH 6.5 | 236 | 53.5 | 0.670 | 2,156 | 1.45 | 32 | 3,857 | 11 | 41 | 2,796 | 24 | 17 | 25 |
| | pH 6.9 | 255 | 55.5 | 0.677 | 2,118 | 1.31 | 31 | 3,963 | 19 | 44 | 2,921 | 22 | 13 | 23 |
| Sample 2 | No lime | 209 | 49.3 | 0.554 | 1,265 | 1.55 | 49 | 3,426 | 17 | 40 | 2,383 | 100 | 19 | 26 |
| added | pH 6.5 | 248 | 53.2 | 0.654 | 1,350 | 1.45 | 31 | 3,780 | 12 | 21 | 2,684 | 26 | 14 | 23 |
| Sample 3 | No lime | 300 | 79.9 | 0.851 | 1,837 | 1.13 | 149 | 5,942 | 9 | 71 | 3,516 | 71 | 14 | 28 |
| added | pH 6.5 | 269 | 82.4 | 0.526 | 1,843 | 1.00 | 33 | 4,325 | 11 | 79 | 3,884 | 45 | 11 | 29 |
| | pH 6.9 | 295 | 79.3 | 0.999 | 1,910 | 1.11 | 27 | 4,834 | 6 | 78 | 3,964 | 23 | 14 | 49 |
| Sample 4 | No lime | 190 | 35.5 | 0.506 | 1,571 | 1.66 | 48 | 3,734 | 15 | 25 | 2,459 | 96 | 12 | 32 |
| added | pH 6.5 | 203 | 37.3 | 0.659 | 1,667 | 1.44 | 43 | 4,290 | 10 | 23 | 2,841 | 35 | 56 | 66 |
| | pH 6.9 | 217 | 39.3 | 0.737 | 1,772 | 1.35 | 9 | 3,971 | 6 | 18 | 2,904 | 26 | 9 | 30 |
| Sample 5 | No lime | 254 | 51.8 | 0.492 | 1,146 | 1.23 | 31 | 3,230 | 9 | 20 | 2,251 | 69 | 12 | 44 |
| added | pH 6.5 | 233 | 45.0 | 0.529 | 1,532 | 1.28 | 24 | 3,444 | 14 | 22 | 2,442 | 22 | 12 | 20 |
| | pH 6.9 | 220 | 52.3 | 0.548 | 1,540 | 1.19 | 13 | 3,907 | 6 | 19 | 2,590 | 27 | 13 | 24 |

Italics indicate missed byproduct treatment

TABLE 8
Corn nutrient and trace-element uptake.

| | | Dry wt. | Total N | P | Ca | Mg | K | Al | Cu | Fe | Mn | Na | Zn |
|---|---|---|---|---|---|---|---|---|---|---|---|---|---|
| Source | Lime trt. | grams | milligrams | | | | | micrograms | | | | | |
| No fertilizer | No lime | 11.4 | 127 | 9 | 54 | 38 | 341 | 732 | 384 | 630 | 1,140 | 225 | 552 |
| added | pH 6.5 | 10.2 | 153 | 16 | 79 | 52 | 346 | 926 | 321 | 1,089 | 462 | 289 | 647 |
| | pH 6.9 | 18.6 | 165 | 16 | 100 | 58 | 367 | 577 | 306 | 917 | 672 | 329 | 841 |
| 18-46-0 starter | No lime | 53.0 | 226 | 60 | 155 | 104 | 668 | 2,676 | 957 | 1,789 | 4,286 | 1,005 | 1,098 |
| fertilizer added | pH 6.5 | 41.1 | 227 | 54 | 111 | 91 | 469 | 824 | 372 | 780 | 905 | 480 | 779 |
| | pH 6.9 | 57.1 | 305 | 66 | 193 | 136 | 551 | 1,123 | 481 | 1,022 | 1,501 | 654 | 1,062 |
| Sample 1 added | No lime | 44.1 | 238 | 99 | 154 | 117 | 678 | 2,022 | 653 | 1,117 | 3,939 | 865 | 1,225 |
| | pH 6.5 | 58.3 | 351 | 112 | 208 | 151 | 763 | 1,853 | 602 | 2,358 | 1,264 | 862 | 1,411 |
| | pH 6.9 | 53.6 | 371 | 116 | 222 | 162 | 723 | 1,622 | 1,207 | 2,552 | 1,207 | 726 | 1,275 |
| Sample 2 added | No lime | 58.0 | 273 | 62 | 166 | 116 | 753 | 2,396 | 789 | 1,952 | 4,819 | 921 | 1,296 |
| | pH 6.5 | 53.2 | 348 | 72 | 201 | 143 | 774 | 1,667 | 631 | 1,143 | 1,381 | 747 | 1,221 |
| | pH 6.9 | 26.7 | 238 | 20 | 106 | 67 | 389 | 372 | 233 | 802 | 611 | 151 | 669 |
| Sample 3 added | No lime | 101.9 | 553 | 127 | 342 | 267 | 733 | 7,566 | 668 | 6,011 | 6,546 | 831 | 2,086 |
| | pH 6.5 | 88.5 | 506 | 137 | 330 | 306 | 763 | 2,664 | 904 | 6,913 | 4,310 | 896 | 2,286 |
| | pH 6.9 | 87.5 | 779 | 149 | 384 | 313 | 869 | 2,166 | 455 | 6,245 | 1,826 | 1,122 | 3,752 |
| Sample 4 added | No lime | 32.8 | 181 | 56 | 133 | 87 | 589 | 1,700 | 530 | 907 | 3,419 | 423 | 1,135 |
| | pH 6.5 | 33.7 | 247 | 63 | 161 | 107 | 542 | 1,532 | 381 | 844 | 1,323 | 1,922 | 2,348 |
| | pH 6.9 | 31.2 | 293 | 69 | 156 | 114 | 526 | 357 | 245 | 707 | 1,008 | 371 | 1,127 |
| Sample 5 added | No lime | 58.0 | 251 | 61 | 167 | 116 | 639 | 1,545 | 437 | 978 | 3,700 | 627 | 2,377 |
| | pH 6.5 | 45.0 | 238 | 69 | 155 | 110 | 575 | 1,100 | 621 | 974 | 984 | 545 | 888 |
| | pH 6.9 | 37.5 | 280 | 80 | 208 | 138 | 617 | 768 | 356 | 1,093 | 1,330 | 674 | 1,269 |

Italics indicate missed byproduct treatment

Although Sample 3 had been treated with ammonia, an analysis of ammonium content by KCl displacement yielded values less those measured for the other samples. This suggests that ammonium ions are held in the byproduct complex more strongly than ammonium ions held on the soil exchange complex.

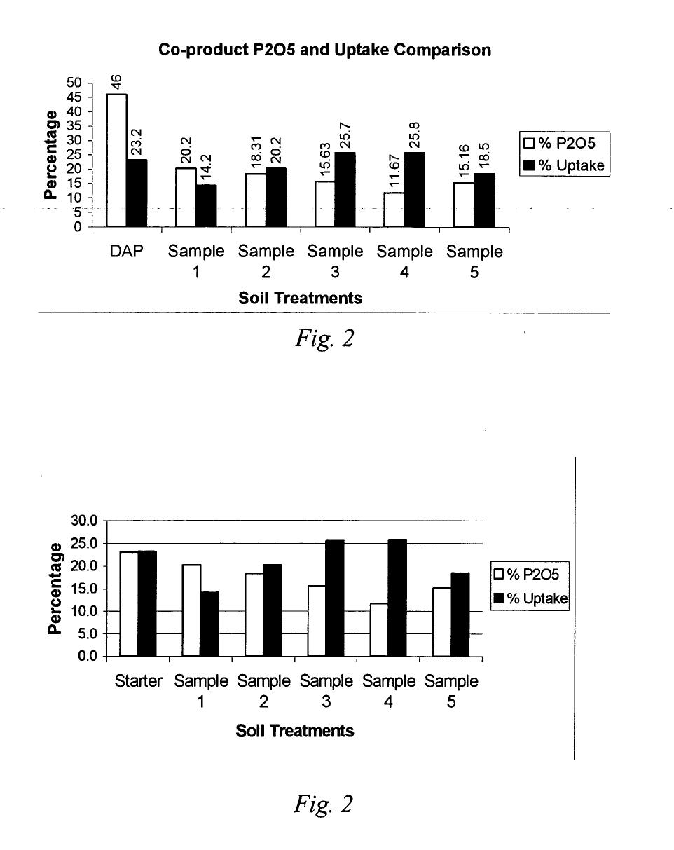

FIG. 2 illustrates the phosphorous content of the phosphorous sources (stated as weight percent) and the percentage phosphorous uptake in the plants in each of the pots. As evident from FIG. 2, Samples 3 and 4 yielded excellent phosphorous uptake results. This, combined with the nitrogen content of Samples 3 and 4, suggests that they would make excellent starter fertilizers or components thereof.

Unless the context clearly requires otherwise, throughout the description and the claims, the words “comprise,” “comprising,” and the like are to be construed in an inclusive sense as opposed to an exclusive or exhaustive sense, that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

The above-detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, whereas steps are presented in a given order, alternative embodiments may perform steps in a different order. The various embodiments described herein can be combined to provide further embodiments.

In general, the terms used in the following claims should not be construed to limit the invention to the specific embodiments disclosed in the specification, unless the above-detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

1. A method for making fertilizer comprising:
steeping corn in water to yield a steepwater comprising water and solubles from the corn, the solubles including an initial phosphorous content;
mixing the steepwater with at least one of calcium hydroxide, magnesium hydroxide, and ammonium hydroxide in an amount effective to yield a pH of at least about 5 and to precipitate at least about 75% of the initial phosphorous content of the steepwater;
separating a phosphorous-rich precipitate from the steepwater;
drying the phosphorous-rich precipitate; and
forming a solid fertilizer composition from the phosphorous-rich precipitate.

2. The method of claim 1 wherein forming the solid fertilizer composition comprises hydrolyzing the phosphorous-rich precipitate.

3. The method of claim 1 wherein forming the solid fertilizer composition comprises hydrolyzing the phosphorous-rich precipitate prior to drying the phosphorous-rich precipitate.

4. The method of claim 1 wherein forming the solid fertilizer composition comprises oxidizing the dried phosphorous-rich precipitate to yield an ash.

5. The method of claim 1 wherein the phosphorus-rich precipitate includes at least about 1.5 weight percent nitrogen.

6. The method of claim 1 wherein the phosphorus-rich precipitate includes no more than about 0.1 weight percent ammonium nitrogen and at least about 1.5 weight percent total nitrogen.

7. The method of claim 1 wherein the phosphorus-rich precipitate includes an oxalate salt.

8. The method of claim 1 wherein the phosphorus-rich precipitate includes at least one secondary nutrient selected from the group consisting of calcium, magnesium, and sulfur, the secondary nutrient comprising at least about 10 weight percent of the precipitate on a dry basis.

9. The method of claim 1 wherein the phosphorus-rich precipitate includes at least one micronutrient selected from the group consisting of manganese, zinc, copper, molybdenum, copper, and iron, the micronutrient comprising at least 1000 ppm of the precipitate on a dry basis.

10. The method of claim 1 wherein the precipitate is hydrolyzed at a pH of no greater than about 3.5.

11. The method of claim 1 wherein hydrolyzing the phosphorus-rich precipitate yields a hydrolyzed precipitate and the method further comprises adjusting a pH of the hydrolyzed precipitate prior to use as a fertilizer.

12. A fertilizer comprising a hydrolyzed precipitate made by the method of claim 1.

13. A method for making fertilizer comprising:
mixing steepwater with a hydroxide selected from the group consisting of calcium hydroxide, magnesium hydroxide, ammonium hydroxide, and mixtures thereof to provide a phosphorus precipitated steepwater, the hydroxide being in an amount effective to precipitate the phosphorus in the steepwater and to provide phosphorus complex;
separating a phosphorus-rich precipitate; and
hydrolyzing the phosphorus-rich precipitate to make fertilizer.

14. The method of claim 13 wherein the steepwater comprises a corn steepwater including corn solubles.

15. The method of claim 13 wherein the phosphorus-rich precipitate includes at least about 1.5 weight percent nitrogen.

16. The method of claim 13 wherein the phosphorus-rich precipitate includes no more than about 0.1 weight percent ammonium nitrogen and at least about 1.5 weight percent total nitrogen.

17. The method of claim 13 wherein the phosphorus-rich precipitate includes an oxalate salt.

18. The method of claim 13 wherein the phosphorus-rich precipitate includes at least one secondary nutrient selected from the group consisting of calcium, magnesium, and sulfur, the secondary nutrient comprising at least about 10 weight percent of the precipitate on a dry basis.

19. The method of claim 13 wherein the phosphorus-rich precipitate includes at least one micronutrient selected from the group consisting of manganese, zinc, copper, molybdenum, copper, and iron, the micronutrient comprising at least 1000 ppm of the precipitate on a dry basis.

20. The method of claim 13 wherein the precipitate is hydrolyzed at a pH of no greater than about 3.5.

21. The method of claim 13 wherein hydrolyzing the phosphorus-rich precipitate yields a hydrolyzed precipitate and the method further comprises adjusting a pH of the hydrolyzed precipitate prior to use as a fertilizer.

22. A fertilizer comprising a hydrolyzed precipitate made by the method of claim 13.

23. A method for making fertilizer comprising:
mixing steepwater with an alkaline metal hydroxide to provide a phosphorus precipitated steepwater, the hydroxide being in an amount effective to precipitate at least about 75% of the phosphorus in the steepwater;
separating from the steepwater a phosphorus-rich precipitate that comprises an organic phosphorous component and an inorganic phosphorous component, the inorganic phosphorous component comprising a phosphorous salt of the metal; and
converting at least a majority of the organic phosphorus component to inorganic phosphorous.

24. The method of claim 23 wherein the phosphorus-rich precipitate includes at least about 1.5 weight percent nitrogen.

25. The method of claim 23 wherein the phosphorus-rich precipitate includes no more than about 0.1 weight percent (wt %) ammonium nitrogen and at least about 1.5 wt % total nitrogen.

26. The method of claim 23 wherein the phosphorus-rich precipitate includes an oxalate salt.

27. The method of claim 23 wherein the phosphorus-rich precipitate includes at least one secondary nutrient selected from the group consisting of calcium, magnesium, and sulfur, the secondary nutrient comprising at least about 10 weight percent of the precipitate on a dry basis.

28. The method of claim 23 wherein the phosphorus-rich precipitate includes at least one micronutrient selected from the group consisting of manganese, zinc, copper, molybdenum, copper, and iron, the micronutrient comprising at least 1000 ppm of the precipitate on a dry basis.

29. The method of claim 23 wherein the precipitate is hydrolyzed at a pH of no greater than about 3.5.

30. The method of claim 23 wherein converting the organic phosphorus component comprises hydrolyzing the phosphorous-rich precipitate to yield a hydrolyzed precipitate and the method further comprises adjusting a pH of the hydrolyzed precipitate prior to use as a fertilizer.

31. A fertilizer comprising a hydrolyzed precipitate made by the method of claim 23.
